(19) United States
(12) Patent Application Publication
(10) Pub. No.: US 2019/0242673 A1
(43) Pub. Date: Aug. 8, 2019

(54) VARIABLE VOLTAGE POWER SUPPLY

(71) Applicants: Jamin Devereaux Heath, Salt Lake City, UT (US); William Devereaux Heath, Riverton, UT (US)

(72) Inventors: Jamin Devereaux Heath, Salt Lake City, UT (US); William Devereaux Heath, Riverton, UT (US)

(21) Appl. No.: 16/249,849

(22) Filed: Jan. 16, 2019

Related U.S. Application Data
(60) Provisional application No. 62/618,043, filed on Jan. 16, 2018.

(51) Int. Cl. F41B 11/71; H02J 7/02; H02J 7/00

(52) U.S. Cl. CPC F41B 11/71; H02J 7/0065; H02J 7/0091; H02J 7/022

(57) ABSTRACT

The disclosure extends to methods, systems, and devices for providing a variable voltage power supply to a hobby device. A system includes a hobby device and a variable voltage power supply. The variable voltage power supply includes a battery, a buck converter comprising an inductor coil and a capacitor, one or more multimeters configured to provide a reading in real-time of a voltage provided by the variable voltage power supply, and an output voltage regulator. The variable voltage power supply may also include a potentiometer, a heat dissipation fin, and a MOSFET.

### CROSS-REFERENCE TO RELATED APPLICATIONS

This application claims the benefit of U.S. Provisional Application No. 62/618,043, filed Jan. 16, 2018, which is incorporated herein by reference in its entirety, including but not limited to those portions that specifically appear hereinafter, the incorporation by reference being made with the following exception: In the event that any portion of the above-referenced provisional application is inconsistent with this application, this application supersedes said above-referenced provisional application.

### BACKGROUND

The disclosure relates to methods, systems, and devices for a variable voltage power supply. The disclosure particularly relates to methods, systems, and devices for providing a variable voltage power supply in a hobby device.

A variety of power supplies have been developed, described, and are widely known for providing power to a hobby device such as an airsoft weapon. In certain applications, a hobby device may withstand a non-standard voltage that cannot be readily purchased in the market. In such an application, a user may wish to maximize the power threshold of the hobby device and provide a power supply that may meet or approach the threshold. The flexibility in power capabilities of a hobby device may be optimized by providing a variable voltage power supply to the hobby device. The variable voltage power supply may enable a user to adjust and optimize the voltage output by the power supply.

The features and advantages of the disclosure will be set forth in the description, which follows, and in part will be apparent from the description, or may be learned by the practice of the disclosure without undue experimentation. The features and advantages of the disclosure may be realized and obtained by means of the instruments and combinations particularly pointed out in the appended claims. Any discussion of documents, acts, materials, devices, articles or the like, which has been included in the specification is not to be taken as an admission that any or all these matters form part of the prior art base, or were common general knowledge in the field relevant to the disclosure as it existed before the priority date of each claim of this disclosure.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the follow description and accompanying drawings where:

FIG. 1 illustrates an exploded perspective view of a variable voltage power supply, according to one implementation;

FIG. 2 illustrates an exploded perspective view of a variable voltage power supply, according to one implementation;

FIG. 3 illustrates a top perspective view of a variable voltage power supply, according to one implementation;

FIG. 4 illustrates an exploded perspective view of a variable voltage power supply, according to one implementation;

FIG. 5 illustrates an aerial top view of a variable voltage power supply, according to one implementation;

FIG. 6 illustrates a top perspective view of a variable voltage power supply, according to one implementation;

FIG. 7 illustrates an aerial top view of a variable voltage power supply, according to one implementation; and

FIG. 8 illustrates a top perspective view of a variable voltage power supply, according to one implementation.

### DETAILED DESCRIPTION

The disclosure extends to methods, systems, and devices for a variable voltage power supply, and particularly extends to providing a variable voltage power supply in a hobby device.

Before the methods, systems and devices for providing a variable voltage power supply in a hobby device are disclosed and described, it is to be understood that this disclosure is not limited to the configurations, process steps, and materials disclosed herein as such configurations, process steps, and materials may vary somewhat. It is also to be understood that the terminology employed herein is used for describing implementations only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

As used herein, the term “airsoft weapon” is defined broadly to include all automatic electric guns (sometimes referred to as AEGs) and low-power air guns, including low-power smoothbore air guns designed to shoot non-metallic spherical projectiles and paintball markers or guns. The term includes mechanical airsoft weapons including a coil spring-loaded piston air pump, and pneumatic airsoft weapons including a valve-controlled release of prefilled bottled gas.

In an embodiment of the disclosure, a variable voltage power supply is provided for a hobby device. The variable voltage power supply includes a battery and a buck converter configured to provide DC-to-DC step down conversion of the battery output voltage. The variable voltage power supply may be encased in a battery casing providing security to the components and providing access to a user to adjust the interior components and alter the output voltage provided by the buck converter.

In an embodiment of the disclosure, an airsoft weapon includes a variable voltage power supply. The variable voltage power supply includes a battery and a converter that is configured to step down or step up the voltage output by the battery. In an embodiment, a user may control the voltage output by the battery and may view, by way of a multimeter, the voltage that is provided to the components of the airsoft weapon. In such an embodiment, a user may alter the output voltage of the battery to suit different applications of the airsoft weapon or to accommodate changes or updates made to the components of the airsoft weapon. In an embodiment, a user may utilize a battery capable of providing voltage above a threshold level that can be received by the components of the airsoft weapon, and the user may step down the maximum voltage to ensure the safety of internal components of the airsoft weapon.

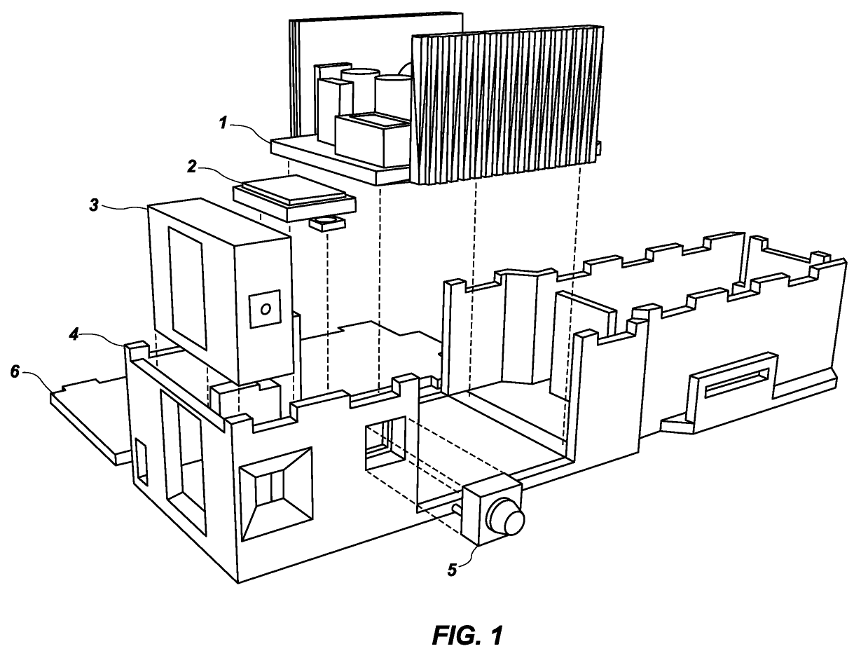

Referring now to FIG. 1, there is illustrated an exploded perspective view of a variable voltage power supply 100. The variable voltage power supply 100 includes a buck converter 110, such as a DC-DC step down buck converter. The variable voltage power supply 100 includes a first multimeter 120 and a second multimeter 130. The variable voltage power supply 100 includes a battery casing 140 and a battery lid 160. The variable voltage power supply 100 further includes an output voltage regulator 150 located at an exterior of the battery casing 140.

The output voltage regulator 150 comprises a potentiometer. The output voltage regulator 150 may be turned by a user to adjust the output voltage of the variable voltage power supply 100. The variable voltage regulator 150 indicates the output voltage to be produced by the buck converter 110 in stepping down the input voltage from a battery. As a user adjusts the output voltage regulator 150 to adjust the output voltage of the buck converter 110, the new output voltage will be reflected in real-time on the first multimeter 120. The output voltage regulator 150 is configured to provide an accessible and convenient means for a user to adjust the output voltage of the buck converter 110. In an embodiment, the buck converter 110 further comprises potentiometers (see 508) and these potentiometers may difficult for a user to access. The output voltage regulator 150 provides an easily accessible potentiometer for adjusting the output voltage of the buck converter 110 without removing the battery lid 160 or accessing the internal components of the variable voltage power supply 100.

The battery casing 140 is configured to store components of the variable voltage power supply 100 including the buck converter 110, the first multimeter 120, and the second multimeter 130. In an embodiment, the battery casing 140 is shaped such that the variable voltage power supply 100 can bet utilized by an airsoft weapon. It should be appreciated that the battery casing 140 may be constructed of any suitable material, including for example, a plastic material, a metal or metal alloy, a wood material, and so forth. In an embodiment, the battery casing 140 includes one or more windows or openings such that a user may view the internal components of the variable voltage power supply 100 without removing the battery lid 160 that encloses the internal components.

The buck converter 110 includes a DC-to-DC variable voltage step down or step up converter. In an embodiment, the buck converter 110 steps down voltage (while stepping up current) from its input power supply to its output load. It should be appreciated that the buck converter 110 is in a class of switched-mode supply (SMPS) as known in the art, typically comprising one or more semiconductors, such as a diode and a transistor, and one or more energy storage elements, such as a capacitor, and inductor, or a capacitor and an inductor in combination. In an embodiment to reduce voltage ripple, filters formed from capacitors may be added to the buck converter's 110 output and input.

The buck converter 110 is highly efficient (sometimes greater than 90% efficiency) at converting an incoming power supply voltage down to a lower voltage as required. In an embodiment, the buck converter 110 steps down an incoming voltage to optimize the voltage for a hobby device, as required by the system components of the hobby device. The buck converter 110 includes current in an inductor controlled by two switches, wherein the switches may comprise a transistor and a diode. For purposes of disclosing and describing the buck converter 110, it may be understood that the switch and the diode comprise zero voltage drop when turned on, and comprise zero current flow when turned off, and the inductor comprises zero series resistance. It may be further assumed that the input and output voltages of the buck converter 110 do not change over the course of a cycle of use.

The first multimeter 120 and the second multimeter 130 are configured to provide a voltage readout at different stages of stepping up or stepping down the voltage within the buck converter 110. In an embodiment, one of the first multimeter 120 or the second multimeter 130 is configured to provide an output voltage indicating the voltage being provided to, for example, a hobby device. In an embodiment, one of the first multimeter 120 or the second multimeter 130 is configured to provide an output voltage indicating the voltage being provided to each cell. In an embodiment, the first multimeter 120 indicates the in real-time the output voltage from the buck converter 110. In an embodiment, the second multimeter 130 indicates in real-time the voltage received directly from a battery. In an embodiment, one of two connectors are supplied on a standard multi-cell lithium-polymer battery that permit voltage measurement of each individual cell of the battery. The voltage measurement of each individual cell is displayed on the second multimeter 130 and permits a user to adjust and set a vibration alert when the voltage drops to a number set by the user. In an embodiment, the variable voltage power supply 100 further includes an alarm for indicating that the voltage has dropped below the number set by the user.

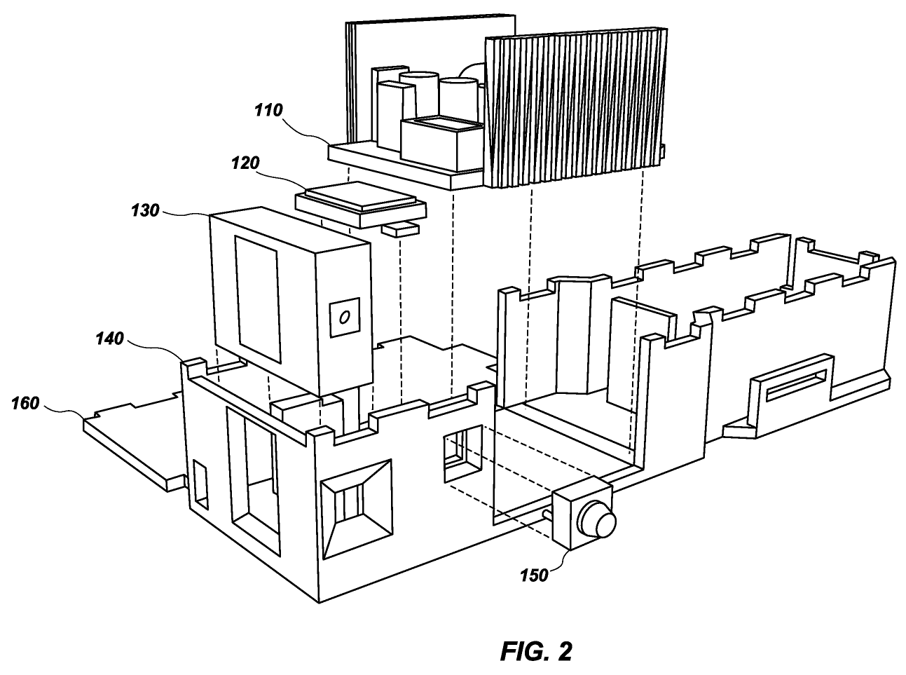

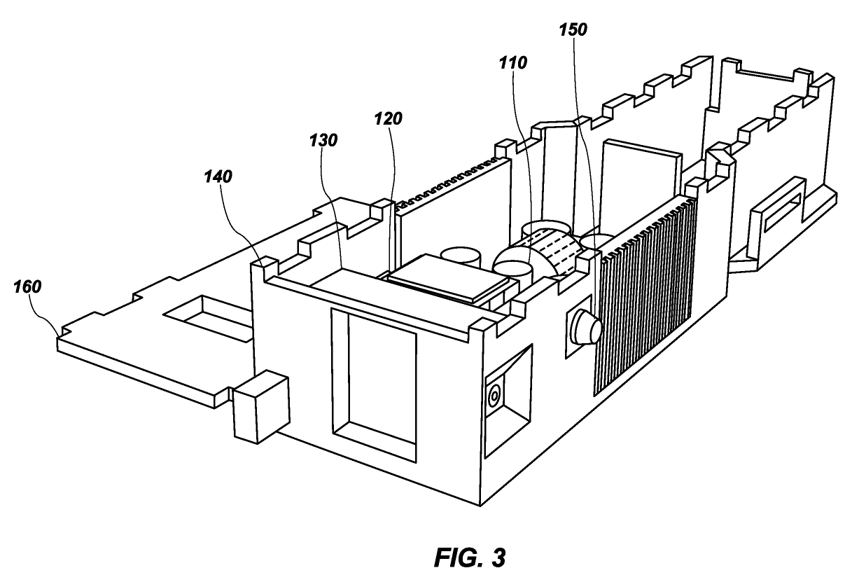

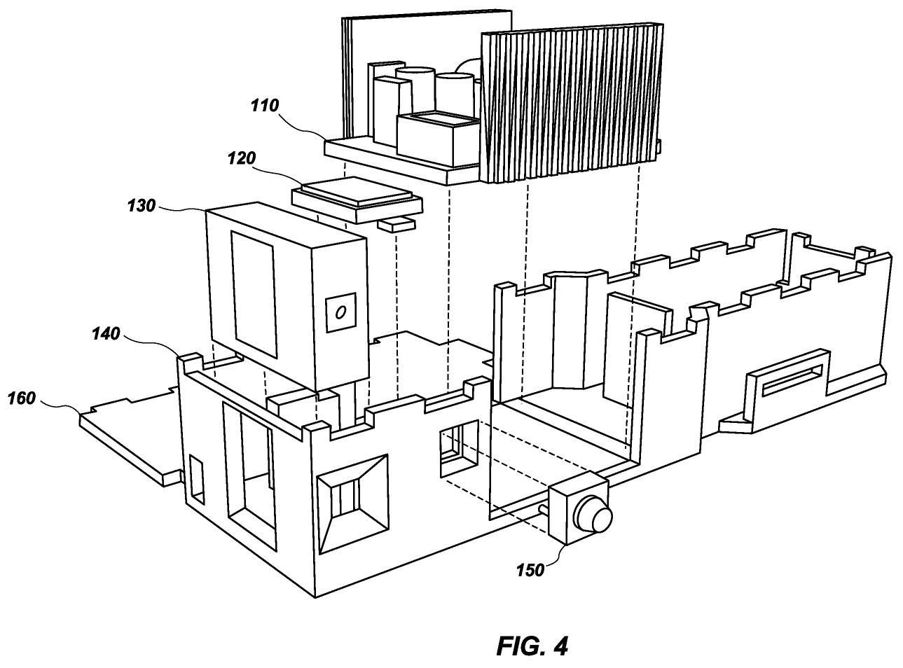

FIGS. 2-4 illustrate various perspectives of the variable voltage power supply 100 as disclosed with reference to FIG. 1. FIG. 2 illustrates an exploded perspective view of the variable voltage power supply 100. FIG. 3 illustrates a perspective view of the variable voltage power supply 100 wherein all components are stored within the battery casing 140 and the battery lid 160 is stored to the side such that the inner components of the variable voltage power supply 100 may be seen. FIG. 4 illustrates an exploded perspective view of the variable voltage power supply 100.

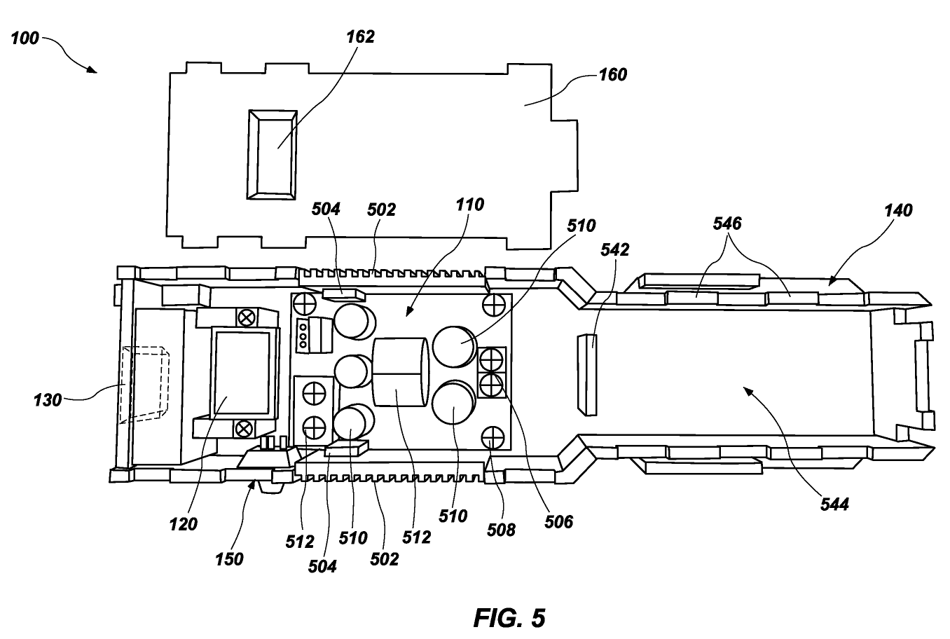

Referring now to FIG. 5, an aerial view of the variable voltage power supply 100 is illustrated. The variable voltage power supply 100 includes a buck converter 110 stored within a battery casing 140. The variable voltage power supply 100 includes a first multimeter 120 and a second multimeter 130, along with an output voltage regulator 150.

The buck converter 110 includes a heat dissipation fin 502 and a metal-oxide-semiconductor field-effect transistor (MOSFET) 504. In an embodiment, the heat dissipation fin 502 is configured to provide an outlet for heat produced specifically by the MOSFET 504. The buck converter 110 includes an inductor coil 512 and a capacitor 510. The buck converter 110 includes a potentiometer 508 for adjusting an output voltage. The buck converter 110 includes a wire connection 506 configured for receiving an input wire and an output wire such that the input wire carries a DC voltage at an input voltage, and the output wire carries a DC voltage at an output voltage.

In an embodiment as pictured in FIG. 5, the buck converter 110 includes five capacitors 510 and a single inductor coil 512. Further as illustrated in FIG. 5, the buck converter 110 includes two potentiometers 508 having a sliding or rotating contact that forms an adjustable voltage divider. The potentiometer 508 serves as a voltage divider for measuring electric potential, and in the case of a buck converter 110, control how a voltage is stepped down. Further as illustrated in FIG. 5, the buck converter 110 includes two heat dissipation fins 502 and a single MOSFET 504 attached to each heat dissipation fin 502. The heat dissipation fins 502 and MOSFETs 504 flank the upper and lower boundaries of the buck converter 110 as shown in FIG. 5. In an embodiment, the heat dissipation fins 502 can constitute the outer perimeter of a portion of the battery casing 140 such that heated air may escape the variable voltage power supply 100 and is not trapped within the battery casing 140.

The battery casing 140 further includes a support 542 configured to hold a battery that may be stored in a battery storage compartment 544. The support 542 is configured to prohibit a lithium-polymer battery, or any other suitable battery, from sliding into the buck converter 110 or other internal components. The support 542 further protects the battery from external forces that may be applied to battery connections. The battery casing 140 further includes one or more slots 546 configured for receiving a strap to hold a battery in place within the battery storage compartment 544.

In an embodiment as illustrated in FIG. 5, the second multimeter 130 is located near a window or opening in the battery casing 140 such that a user may view a reading on the second multimeter 130 without opening the battery casing 140. In an embodiment, a lid opening 162 is configured to be placed over the first multimeter 120 such that a user may view a reading on the first multimeter 120 without opening the battery casing 140. The buck converter 110 may be in electronic communication with each of the first multimeter 120 and the second multimeter 130.

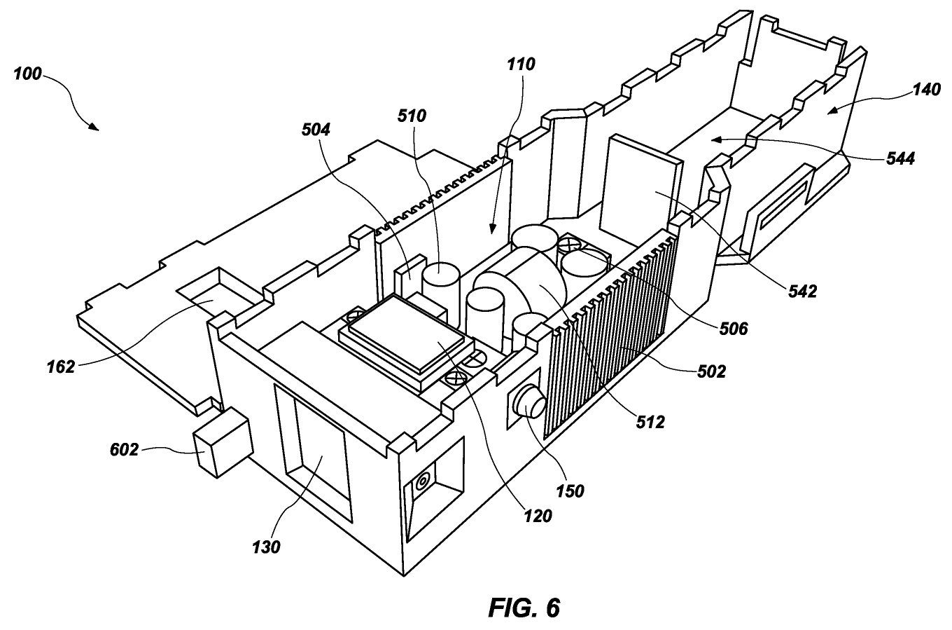

FIG. 6 illustrates a perspective view of a variable voltage power supply 100 including a buck converter 110. The buck converter 110 includes components as disclosed in FIG. 5, including an inductor coil 512, a capacitor 510, a heat dissipation fin 502, a MOSFET 504, a wire connection 506, and other components not readily visible in the perspective seen in FIG. 6. The variable voltage power supply 100 is housed in a battery casing 140 including a plurality of windows or openings that enable a user to view components of the variable voltage power supply 100. In an embodiment, a user may view a reading on the first multimeter 120 through the lid opening 162 when a lid is placed over the battery casing 140. In an embodiment, a user may view a reading on the second multimeter 130 when the battery is stored within the casing 140. A user may further make an adjustment to the buck converter 110 by way of the output voltage regulator 150 without opening the battery casing 140. In an embodiment, the variable voltage power supply 100 further includes a connector 602 such as a Tamiya connector. The connector 602 is configured to provide physical and/or electronic connection between the variable voltage power supply 100 and a hobby device such as an airsoft weapon.

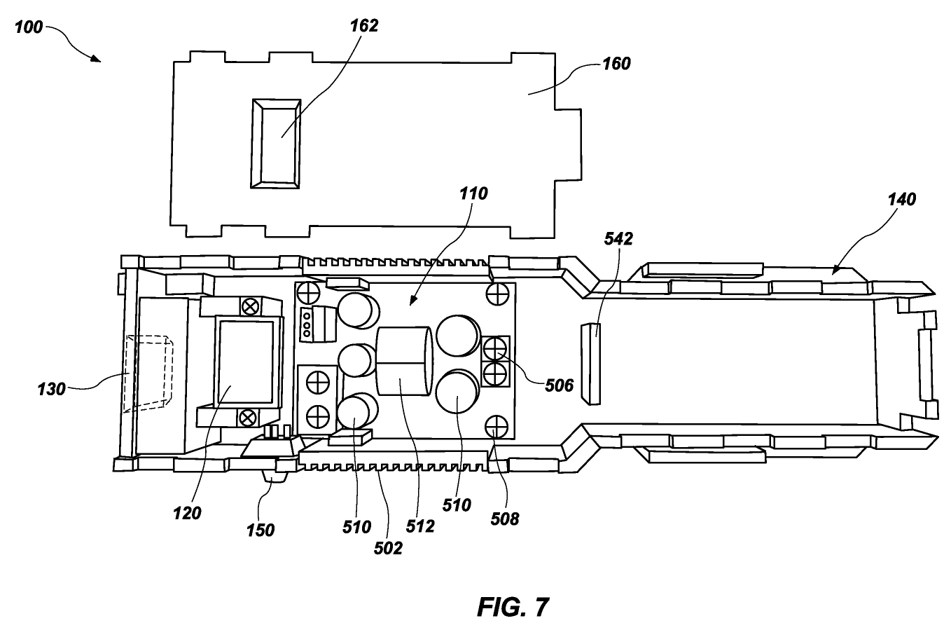

FIG. 7 illustrates an aerial line drawing of the variable voltage power supply 100. The variable voltage power supply 100 includes a battery casing 140 and a battery lid 160 that are configured to encase and protect a plurality of components, including a buck converter 110, a first multimeter 120, and a second multimeter 130. The buck converter 110 includes a plurality of components as illustrated in FIG. 5, including an inductor coil 512, a plurality of capacitors 510, a potentiometer 508, a wire connection 506, and a heat dissipation fin 502.

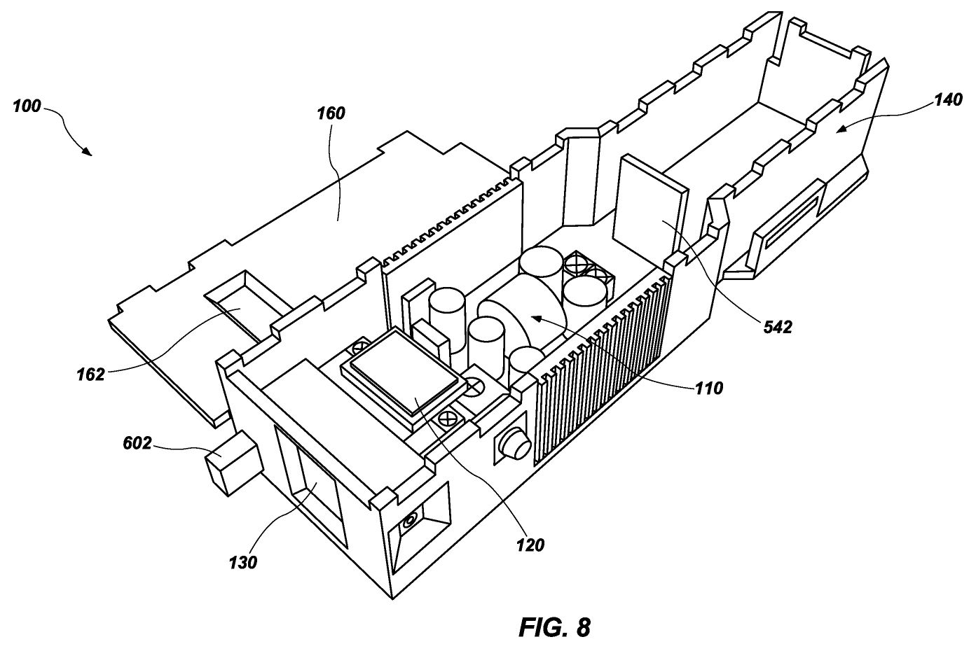

FIG. 8 illustrates a perspective line drawing of the variable voltage power supply 100 as illustrated in FIG. 5-7. The variable voltage power supply 100 includes a battery casing 140 with a battery lid 160 that is configured to be placed on top of and secured to the battery casing 140. The variable voltage power supply includes a buck converter 110, a first multimeter 120, and a second multimeter 130.

It will be appreciated that the variable voltage capabilities provided by the variable voltage power supply 100 allows a user to adjust or vary the speed of the automatic firing capabilities or the discharge force of the airsoft weapon. Thus, for example, to increase the speed of firing the airsoft weapon (e.g., in a semi-automatic or fully automatic setting), the voltage may be increased on the fly by a user. Similarly, to decrease the speed of filing the airsoft weapon (e.g., in a semi-automatic or fully automatic setting), the voltage may be decreased on the fly by a user.

In an embodiment of the disclosure, a variable voltage power supply 100 is integrated in a hobby device to provide a specialized voltage output that is optimized for the hobby device. In an embodiment, the hobby device is an airsoft weapon. In such an embodiment, the variable voltage power supply 100 is located within the airsoft weapon within any suitable location, including for example the Picatinny rails that are commonly providing on airsoft rifles. In an embodiment, a custom rear stock may be provided for housing the variable voltage power supply 100 on the airsoft weapon. In an embodiment, a custom forward grip may be mounted on the Picatinny rail and constructed to house the variable voltage power supply 100 or individual components of the variable voltage power supply 100. In a further embodiment, a belt or accessory holds or supports the variable voltage power supply 100. In an embodiment, the belt or accessory is not secured to the variable voltage power supply 100 but is in electronic communication with it via a connection cable or similar device. In an embodiment, any of the aforementioned connection devices may be used with any AEG airsoft weapon to power any suitable mechanism within the airsoft weapon.

It should be appreciated that airsoft weapons may comprise one of three common powerplants, including a spring-piston power source, a gas power source, or an automatic electric (AEG) power source. In the instance of an AEG power source, the airsoft weapon includes a spring-piston gun and a motor configured to automatically cock the piston of the gun. The motor requires electric power that it may draw from a battery such as a nickel cadmium battery, a nickel metal hydride battery, a lithium-ion battery, or a lithium polymer battery.

In an embodiment, the variable voltage power supply comprises an integral bidirectional up/down voltage converter such that the voltage of the battery does not need to match the voltage of system power lines that are connected to the battery. The integral bidirectional converter may be operated as a buck converter when the battery is charging to efficiently charge the system voltage to match the battery's preferred charging voltage, and as a boost converter when the battery is discharging, to increase the battery voltage to the exact value required by the system. In an embodiment, the battery voltage does not have to be less than the system voltage, but can alternatively be greater if the converter is programmed to achieve such a state. In an embodiment, the voltage conversion ratios do not need to be constant. In an embodiment, the charge and discharge curves are optimized for the exact characteristics of the battery being used to permit greater efficiency of energy extraction from the battery, and in turn translate to greater energy density in the battery.

### EXAMPLES

The following examples pertain to further embodiments.

Example 1 is a system. The system includes a hobby device and a variable voltage power supply. The variable voltage power supply includes a battery, a buck converter comprising an inductor coil and a capacitor, a first multimeter, and a second multimeter. The variable voltage power supply includes an output voltage regulator.

Example 2 is a system as in Example 1, wherein the first multimeter indicates a voltage provided to the hobby device.

Example 3 is a system as in any of Example 1-2, wherein the variable voltage power supply further includes a potentiometer, wherein the potentiometer is configured to adjust the output voltage of the battery.

Example 4 is a system as in any of Examples 1-3, wherein the variable voltage power supply further includes a heat dissipation fin.

Example 5 is a system as in any of Examples 1-4, wherein the variable voltage power supply further includes a MOSFET attached to the heat dissipation fin.

Example 6 is a system as in any of Examples 1-5, wherein the system is configured to provide an optimized output voltage to the hobby device.

Example 7 is a system as in any of Examples 1-6, wherein the hobby device comprises an airsoft weapon.

Example 8 is a system as in any of Examples 1-7, further comprising a battery casing configured to encase the battery, the inductor coil, the capacitor, the first multimeter, and the second multimeter.

Example 9 is a system as in any of Examples 1-8, further comprising a buck converter configured to provide DC-to-DC step down voltage conversion for the battery.

Example 10 is a system as in any of Examples 1-9, wherein the variable voltage power supply is integrated in the hobby device to provide a specialized voltage output that is optimized for the hobby device.

Example 11 is a hobby device that includes a variable voltage power supply. The variable voltage power supply includes a battery and a buck converter comprising an inductor coil and a capacitor. The variable voltage power supply further comprises one or more multimeters configured to provide a reading in real-time of a voltage provided by the variable voltage power supply, and an output voltage regulator.

Example 12 is a device as in Example 11, wherein the hobby device is an airsoft weapon. The one or more multimeters comprises a first multimeter and a second multimeter, wherein the first multimeter indicates a voltage provided to the airsoft weapon.

Example 13 is a device as in any of Examples 11-12, wherein the variable voltage power supply further comprises a potentiometer, wherein the potentiometer is configured to adjust the output voltage of the battery.

Example 14 is a device as in any of Examples 11-13, wherein the variable voltage power supply further includes a heat dissipation fin.

Example 15 is a device as in any of Examples 11-14, wherein the variable voltage power supply further comprises a MOSFET attached to the heat dissipation fin.

Example 16 is a device as in any of Examples 11-15, wherein the device is configured to provide an optimized output voltage to the airsoft weapon.

Example 17 is a device as in any of Examples 11-16, wherein the device further comprises a battery casing configured to encase the battery, the inductor coil, the capacitor, the first multimeter, and the second multimeter.

Example 18 is a device as in any of Examples 11-17, wherein the buck converter provides a DC-to-DC step down voltage conversion for the battery.

Example 19 is a device as in any of Examples 11-18, wherein the variable voltage power supply is integrated in the airsoft weapon to provide a specialized voltage output that is optimized for the airsoft weapon.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

In the foregoing Detailed Description, various features of the disclosure are grouped together in a single implementation for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed implementation. Thus, the following claims are hereby incorporated into this Detailed Description by this reference, with each claim standing on its own as a separate implementation of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A system comprising:
a hobby device; and
a variable voltage power supply;
wherein the variable voltage power supply comprises:
a battery;
a buck converter comprising an inductor coil and a capacitor;
a first multimeter;
a second multimeter; and
an output voltage regulator.

2. The system of claim 1, wherein the first multimeter indicates a voltage provided to the hobby device.

3. The system of claim 1, wherein the variable voltage power supply further comprises a potentiometer, wherein the potentiometer is configured to adjust the output voltage of the battery.

4. The system of claim 1, wherein the variable voltage power supply further includes a heat dissipation fin.

5. The system of claim 4, wherein the variable voltage power supply further comprises a MOSFET attached to the heat dissipation fin.

6. The system of claim 1, wherein the system is configured to provide an optimized output voltage to the hobby device.

7. The system 1, wherein the hobby device comprises an airsoft weapon.

8. The system of claim 1, wherein the system further comprises a battery casing configured to encase the battery, the inductor coil, the capacitor, the first multimeter, and the second multimeter.

9. The system of claim 1, wherein the buck converter provides a DC-to-DC step down voltage conversion for the battery.

10. The system of claim 1, wherein the variable voltage power supply is integrated in the hobby device to provide a specialized voltage output that is optimized for the hobby device.

11. A hobby device comprising:
a variable voltage power supply;
wherein the variable voltage power supply comprises:
a battery;
a buck converter comprising an inductor coil and a capacitor;
one or more multimeters configured to provide a reading in real-time of a voltage provided by the variable voltage power supply; and
an output voltage regulator.

12. The device of claim 11, wherein the hobby device is an airsoft weapon, wherein the one or more multimeters comprises a first multimeter and a second multimeter, wherein the first multimeter indicates a voltage provided to the airsoft weapon.

13. The device of claim 12, wherein the variable voltage power supply further comprises a potentiometer, wherein the potentiometer is configured to adjust the output voltage of the battery.

14. The device of claim 12, wherein the variable voltage power supply further includes a heat dissipation fin.

15. The device of claim 14, wherein the variable voltage power supply further comprises a MOSFET attached to the heat dissipation fin.

16. The device of claim 12, wherein the device is configured to provide an optimized output voltage to the airsoft weapon.

17. The device of claim 12, wherein the device further comprises a battery casing configured to encase the battery, the inductor coil, the capacitor, the first multimeter, and the second multimeter.

18. The device of claim 12, wherein the buck converter provides a DC-to-DC step down voltage conversion for the battery.

19. The device of claim 12, wherein the variable voltage power supply is integrated in the airsoft weapon to provide a specialized voltage output that is optimized for the airsoft weapon.
